(19) United States
(12) Patent Application Publication
(10) Pub. No.: US 2014/0029055 A1
(43) Pub. Date: Jan. 30, 2014

(54) SHEET PROFILE MANAGEMENT METHOD, IMAGE FORMING SYSTEM, AND COMPUTER READABLE RECORDING MEDIUM STORING SHEET PROFILE MANAGEMENT PROGRAM

(71) Applicant: KONICA MINOLTA, INC., Tokyo (JP)

(72) Inventor: Hiroshi SHIMURA, Tokyo (JP)

(73) Assignee: KONICA MINOLTA, INC., Tokyo (JP)

(21) Appl. No.: 13/939,063

(22) Filed: Jul. 10, 2013

(30) Foreign Application Priority Data
Jul. 24, 2012 (JP) 2012-163412

(51) Int. Cl. G06K 15/00

(52) U.S. Cl. CPC G06K 15/40
USPC 358/1.16

(57) ABSTRACT

An image forming system is configured with: an image forming section configured to form, on a sheet, an image based on graphic data; a storing section configured to store sheet profiles which are information about sheets to be used by the image forming section to form images; and a control section configured to manage the sheet profile stored in the storing section and to control the image forming section to form an image, wherein when storing produced sheet profiles in the storing section, the control section associates a plurality of sheet profiles, to be used to perform a predetermined image formation, with each other, and puts the associated sheet profiles in a state where limitation of edit is enforced.

### BACKGROUND OF THE INVENTION

1. Field of the Invention

The present invention relates to the technology for appropriately managing sheet profiles about a sheet used for image forming.

2. Description of Related Art

Image forming devices such as printers and copy machines using an electrophotographic method are equipped with a plurality of trays each for storing each of a plurality of types of sheet to deal with various printing conditions.

In such image forming device, sheet information including attribute information indicating a type of sheet and printing conditions such as a paper type, a weight of paper, a paper color, difference of scale factors between two sides is read out from a storage section and the like and is set for each tray. Here, in an image forming device, such sheet information is managed as a sheet profile.

This arrangement enables the image forming device to identify a certain tray by searching an ID designated by sheet information included in an accepted print job, on the basis of an ID of the sheet information which is set for each tray, whereby sheet is supplied from the identified tray.

Such supply procedure of paper highly inevitable especially in the field of light printing. That is why there are very many types of sheets in the field of light printing, and there is an issue that images cannot be properly formed on a sheet without setting for each sheet detailed printing conditions appropriate for each sheet.

It should be noted that regarding how to deal with sheet information and other various information in such image forming devices, relevant proposals have been made in Japanese Laid-Open Patent Application Publication Nos. 2011-98510, 2010-61677, 2010-212862, 2011-173347, 2010-76282, and the like.

### SUMMARY OF THE INVENTION

In Japanese Laid-Open Patent Application Publication No. 2011-98510, a processing is proposed in which for the purpose of efficient handling of sheet information, when sheet information for one tray is changed, sheet information for another tray having the same attribute information is changed in conjunction therewith.

Japanese Laid-Open Patent Application Publication No. 2010-61677 describes a method in which actual information of a sheet can be registered in association with an arbitrarily named character string, and when print is actually done, an instruction of print accompanied by the registered information enables a tray, in which sheets appropriate to the print are stored, to be automatically selected.

Japanese Laid-Open Patent Application Publication No. 2010-212862 describes, in order to manage the contents of the operation that the operator has done, a method in which the contents of the operation and sheet settings which the operator has done and man-hour are registered in a data base in association with the job.

In Japanese Laid-Open Patent Application Publication No. 2011-173347, proposed is an image forming device having a multiple paper roll configuration in which a paper type, a width of paper, a thickness of paper, an amount of paper, and a roll diameter can be stored for a plurality of rolls of paper. In addition, a method is disclosed in which when a roll paper is newly attached, the width of paper and the thickness of paper are measured, and those values are compared with the stored information; thus, when they are the same, that paper type is applied.

Japanese Laid-Open Patent Application Publication No. 2010-76282 discloses a method in which the information of special paper such as gloss paper can be registered, and the registered special paper is prohibited to be used for other printing.

In the meantime, by the methods described in the above patent documents, the set sheet profile can be registered. However, when reproducing the settings of a job to be executed on a regular basis, it requires a lot of time and effort to find out the sheet profile which has been used before.

In addition, anyone can revise the restored sheet profiles. For this reason, once the sheet profile having been used before has been revised, it is difficult to reproduce the former state of the sheet profile.

Further, in the field of printing, in some cases two trays of a tray (n) and a tray (n+1) are sequentially or alternatively used to form images for one job. When the sheet profile set at this time is registered, the registration is individually done for each sheet profile. For example, the sheet profile for the tray (n) is registered as “sheet profile_No. n”, and the sheet profile for the tray (n+1) is registered as “sheet profile_No. n+1”.

The case of two trays is taken as an example here, but three or more trays are can be used to perform one image formation.

With the form of registration like this, for example, in the case of periodically performing a similar print job on a regular basis, it is necessary to store a plurality of used sheet profiles and to individually read out them, whereby time and effort are required.

In addition, even if only one of the registered sheet profiles has been inadvertently revised when using the sheet profiles of the regularly performed print job, it is difficult to reconstruct all the sheet profiles, whereby the printing operation is disturbed.

An object of the present invention is to facilitate the reconstruction of the sheet profiles when image forming is performed, using paper from a plurality of trays and referring to the sheet profile corresponding to each of the trays.

### Means for Solving the Problems

An image forming system reflecting one aspect of the present invention is configured with the followings:

an image forming section configured to form, on a sheet, an image based on graphic data;

a storing section configured to store sheet profiles which are information about sheets to be used by the image forming section to form images; and

a control section configured to manage the sheet profiles stored in the storing section and to control the image forming section to form an image,

wherein when storing produced sheet profiles in the storing section, the control section associates a plurality of sheet profiles, to be used to perform a predetermined image formation, with each other, and puts the associated sheet profiles in a state where limitation of edit is enforced.

Further, it is preferable that the control section performs, as the limitation of edit, any one of the followings: prohibition of edit; temporal use of a result of edit; and storage of a result of edit with another name.

In addition, the control section controls such that each of the associated sheet profiles contains tray information on a tray in which the sheet is stored.

Further, it is preferable that the control section controls such that each of the associated sheet profiles is assigned with a different tray in which the sheet is stored.

### BRIEF DESCRIPTION OF THE DRAWINGS

FIG. 1 is a block diagram showing a configuration of an image forming device of an embodiment of the present invention;

FIG. 2 is a configuration diagram showing a configuration of an image forming device of an embodiment of the present invention;

FIG. 3 is a configuration diagram showing a configuration of an image forming device of an embodiment of the present invention;

FIG. 4 is a flow chart showing an operation of an image forming device of an embodiment of the present invention;

FIG. 5 is an explanatory diagram of a screen example of an image forming device of an embodiment of the present invention;

FIG. 6 is an explanatory diagram showing an screen example of an image forming device of an embodiment of the present invention;

FIG. 7 is a flow chart showing an operation of an image forming device of an embodiment of the present invention;

FIG. 8 is an explanatory diagram showing a screen example of an image forming device of an embodiment of the present invention;

FIG. 9 is a flow chart showing an operation of an image forming device of an embodiment of the present invention;

FIG. 10 is an explanatory diagram of a screen example of an image forming device of an embodiment of the present invention;

FIG. 11 is an explanatory diagram showing a screen example of an image forming device of an embodiment of the present invention;

FIG. 12 is a flow chart showing an operation of an image forming device of an embodiment of the present invention;

FIG. 13 is an explanatory diagram showing a screen example of an image forming device of an embodiment of the present invention;

FIG. 14 is a flow chart showing an operation of an image forming device of an embodiment of the present invention;

FIG. 15 is a flow chart showing an image forming device of an embodiment of the present invention;

FIG. 16 is an showing a screen example of an image forming device of an embodiment of the present invention;

FIG. 17 is an explanatory diagram of a screen example of an image forming device of an embodiment of the present invention;

FIG. 18 is an explanatory diagram showing a screen example of an image forming device of an embodiment of the present invention;

FIG. 19 is a flow chart showing an operation of an image forming device of an embodiment of the present invention;

FIG. 20 is an explanatory diagram showing a screen example of an image forming device of an embodiment of the present invention;

FIG. 21 is an explanatory diagram showing a screen example of an image forming device of an embodiment of the present invention;

FIG. 22 is a flow chart showing an operation of an image forming device of an embodiment of the present invention;

FIG. 23 is a flow chart showing an operation of an image forming device of an embodiment of the present invention;

FIG. 24 is an explanatory diagram showing a screen example of an image forming device of an embodiment of the present invention;

FIG. 25 is an explanatory diagram showing a screen example of an image forming device of an embodiment of the present invention;

FIG. 26 is a flow chart showing an operation of an image forming device of an embodiment of the present invention; and

FIG. 27 is a flow chart showing an operation of an image forming device of an embodiment of the present invention.

### DETAILED DESCRIPTION OF THE INVENTION

A sheet profile management method, an image forming system, and an example of a sheet profile management program are described in detail below.

### <Configuration of Whole Image Forming System>

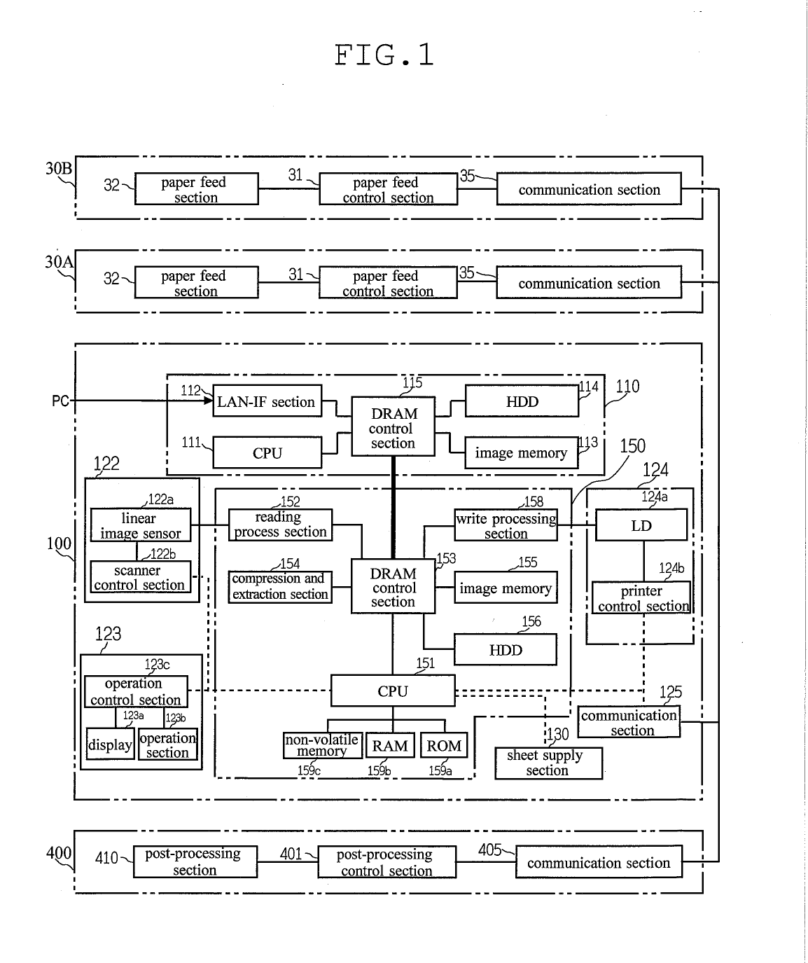

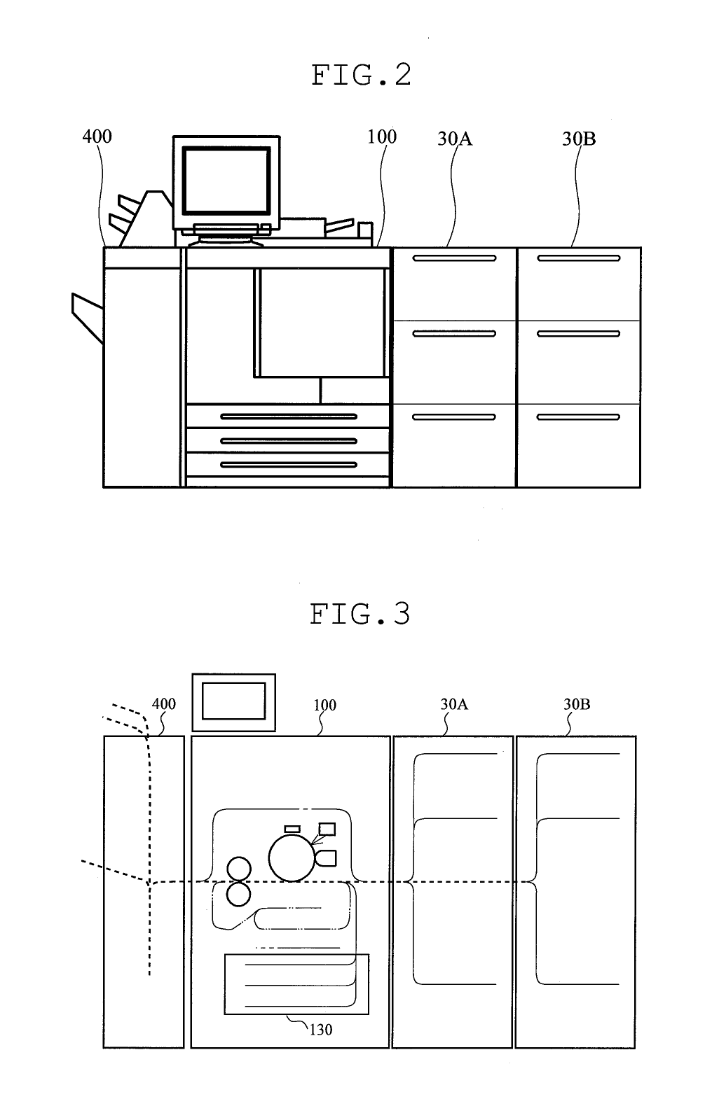

FIGS. 1-3 are explanatory diagrams showing a schematic configuration of an embodiment of the present invention. FIG. 1 shows a configuration of an image forming system of an embodiment. FIG. 2 shows an external configuration of the image forming system of the embodiment. FIG. 3 shows the flow of sheet conveyance in the image forming system.

In these figures, there is shown an image forming system as a specific example which includes a tray unit 30A having a plurality of trays as sheet supply devices, a tray unit 30B having a plurality of trays as sheet supply devices, an image forming device 100, and a post-processing device 400, which devices are series-connected. However, the number of the devices and the connected devices are not limited to this example.

In this image forming system, as shown in FIG. 2 and FIG. 3, the tray unit 30A or 30B, the image forming device 100, and the post-processing device 400, which performs various types of post-processes (for example, a punching process, a stapling process, and a binding process) on the sheets having images formed thereon, are series-connected along the flow of a sheet directed from right to left in the drawing

The tray unit 30A, the tray unit 30B, the image forming device 100, and the post-processing device 400 can be controlled in cooperation by their control sections (a paper feed control section 31, a main control section 150 (CPU 151), and a post-processing control section 401) communicating through their communication sections 35, 125, and 405.

This image forming system can work with an information processing apparatus not shown in the figure. In this case, the information processing apparatus is dealt with as a part of the image forming system.

### <Configuration of Image Forming Device>

FIG. 1 shows a configuration of the image forming device 100 for executing a sheet profile management method of a first embodiment of the present invention. The image forming device 100 is here a main part of the image forming system.

The image forming device 100 is generally configured to include a printer controller 110, a scanner section 122, an operation/display section 123, a printer section 124, a communication section 125, a sheet supply section 130, and a main control section 150.

The printer controller 110 is connected to an information processing apparatus such as personal computer (PC) through a network such as a LAN (Local Area Network). This printer controller 110 executes a raster image processing (RIP) on a print job sent from the information processing apparatus to create image data. Here, the image data are graphic data in bitmap form to be used for image forming.

The print job which the printer controller 110 receives from the information processing apparatus includes print data in which characters and graphics are described in code data or vector data, for example, print data described in PDL (Page Description Language). The raster image processing (RIP) is a processing to extract print data configured with code data or vector data into image data in bitmap form.

The printer controller 110 includes a CPU (Central Processing Unit) 111, a LAN-IF section 112, an image memory 113, a hard disk device (HDD) 114, and a DRAM (Dynamic Random Access Memory) control section 115.

The CPU 111 functions here as a controller controlling section for comprehensively controlling the operation of the printer controller 110. The LAN-IF section 112 has a function of communication for connecting to the network. The image memory 113 stores the image data generated by the RIP and other data. The HDD 114 accumulates print data received from the network, intermediate data generated in the process of the RIP, and other data. The DRAM control section 115 has a function for reading/writing data in the image memory 113 and for transmitting/receiving various kinds of data to and from the printer section 124.

Other than these devices, a ROM (Read Only Memory), a work memory, and the like are connected to the CPU 111 although they are not shown in the drawing. The ROM here stores a program to be read out and be executed by the CPU 111 and fixed data. The work memory temporarily stores various kinds of data when the CPU 111 executes the program.

The scanner section 122 has a function for optically reading a document in color or monochrome and acquiring the corresponding graphic data. This scanner section 122 has, in addition to a linear image sensor 122a, a scanner control section 122b for controlling the whole operation of the scanner section 122.

The operation/display section 123 has a display function and an input function. The display function displays to the operator various kinds of setting screens, operation screens, various kinds of guidance information, various kinds of notices, various kinds of alerts, and the like. The input function receives from the operator various kinds of setting/selection operations, editing operations, and an output instruction (instruction of starting image forming). The operation/display section 123 is configured to include a display 123a made up of a liquid crystal display, an operation section 123b made up of various kinds of switches installed thereon, and an operation control section 123c for controlling the display 123a and the operation section 123b.

The printer section 124 has laser diodes (LD) 124a which are made on and off depending on graphic data and a printer control section 124b for controlling the operation of a process unit and the like. This printer section 124 constitutes an image forming section.

The scanner control section 122b, the operation control section 123c, and the printer control section 124b are each made up of a circuit having as a main part a CPU, a ROM, a DRAM, and the like. The scanner control section 122b, the operation control section 123c, and the printer control section 124b execute various kinds of controls according to programs stored in the ROMs.

The sheet supply section 130 is instructed by the CPU 151 to send out the sheets stored in the trays in synchronism with the timing of the image forming.

The main control section 150 has a function for comprehensively controlling the whole operation of the image forming device 100 in coordination with the control sections in the other sections. This main control section 150 is configured with the CPU 151, a reading process section 152, a DRAM control section 153, a compression and extraction section 154, an image memory 155 made up of a semiconductor memory, a hard disk device (HDD) 156, a write processing section 158, a ROM 159a, a RAM 159b, and a non-volatile memory 159c.

The CPU 151 has a function for controlling the whole operation about image forming. The ROM 159a stores programs, various kinds of fixed data, and the like. The CPU 151 operates according to the programs stored in the ROM 159a. The RAM 159b is used as a work memory to temporarily store various kinds of data when the CPU 151 executes programs. The non-volatile memory 159c stores user data, system data, various kinds of set values, and the like which should be stored even after the power is off.

The reading process section 152 has functions for an enlargement processing, a mirror image processing, an error diffusion processing, and the like.

The DRAM control section 153 performs a timing control for reading out from, writing in, or refreshing the image memory 155 made up of a dynamic RAM and a timing control when compressing graphic data to store them in the image memory 155 and when reading out the compressed graphic data from the image memory 155 and extracting them.

In addition, the DRAM control section 153 is connected to the DRAM control section 115 in the printer controller 110 through a PCI (Peripheral Component Interconnect) bus. Thus, the DRAM control section 153 has a function for delivering and receiving various kinds of data to and from the printer controller 110.

The compression and extraction section 154 has a compression function and an extraction function. In particular, using the image memory 155 as an memory area, the compression and extraction section 154 compresses graphic data to generate compressed graphic data and extracts compressed graphic data (compressed graphic data) into original image data.

The image memory 155 is used by the compression and extraction section 154 and stores the compressed graphic data generated by compression and the extracted graphic data.

The hard disk device 156 memorizes and stores print job data (job data) received from the printer controller 110 and other data.

The write processing section 158 provides signals for letting the LD 124a of respective colors in the printer section 124 on and off depending on the graphic data read out from the image memory 155 and extracted, at the timing in synchronism with the operation of the printer section 124.

### <Configuration of Sheet Supply Section and Tray Unit>

As shown in FIG. 2 and FIG. 3, this embodiment has the sheet supply section 130 having triple trays, the tray unit 30A having triple trays, and the tray unit 30B having triple trays.

It should be noted that the number of stacked trays and the number of units are only examples, and the trays and the units can be arbitrarily increased or decreased in increments of a tray or a unit.

### <Definitions of Terms>

In this embodiment, sheet information including attribute information indicating a type of sheet such as a paper type, a weight of paper, and a paper color of the sheet used in the image forming device and printing conditions such as a difference of scale factors between two sides, a setting voltage of charging, and a transfer voltage is referred to as “sheet profile” as an aggregation of information.

Further, this sheet profile is set as the sheet information made to correspond to any one of the trays or the sheet information not made to correspond to any of the trays and is stored in the non-volatile memory 159c and the like.

In addition, these sheet profiles are stored in the storing section such as non-volatile memory 159c and the like in the state in which a plurality of sheet profiles to be referred to when a predetermined image forming is performed are associated with each other, and in the state in which edit of the associated sheet profiles is limited.

### <Sheet Profile Management (1)>

A first example of a sheet profile management in the image forming system of the embodiment is described here with reference to the flow charts and the examples of screen display. Here, description is made on setting and registration of a sheet profile made to correspond to any one tray in the tray unit 30 or in the sheet supply section 130.

It should be noted that the sheet profile management of the embodiment can be performed also through an external computer; however, a description here is made taking the case as a specific example, in which case the management is performed by the main control section 150 through the operation/display section 123 of the image forming device 100.

In addition, the main control section 150 performs the sheet profile management below by causing a sheet profile management program included in an image forming program to be executed. However, in this embodiment, description is made in the case of the control of the main control section 150.

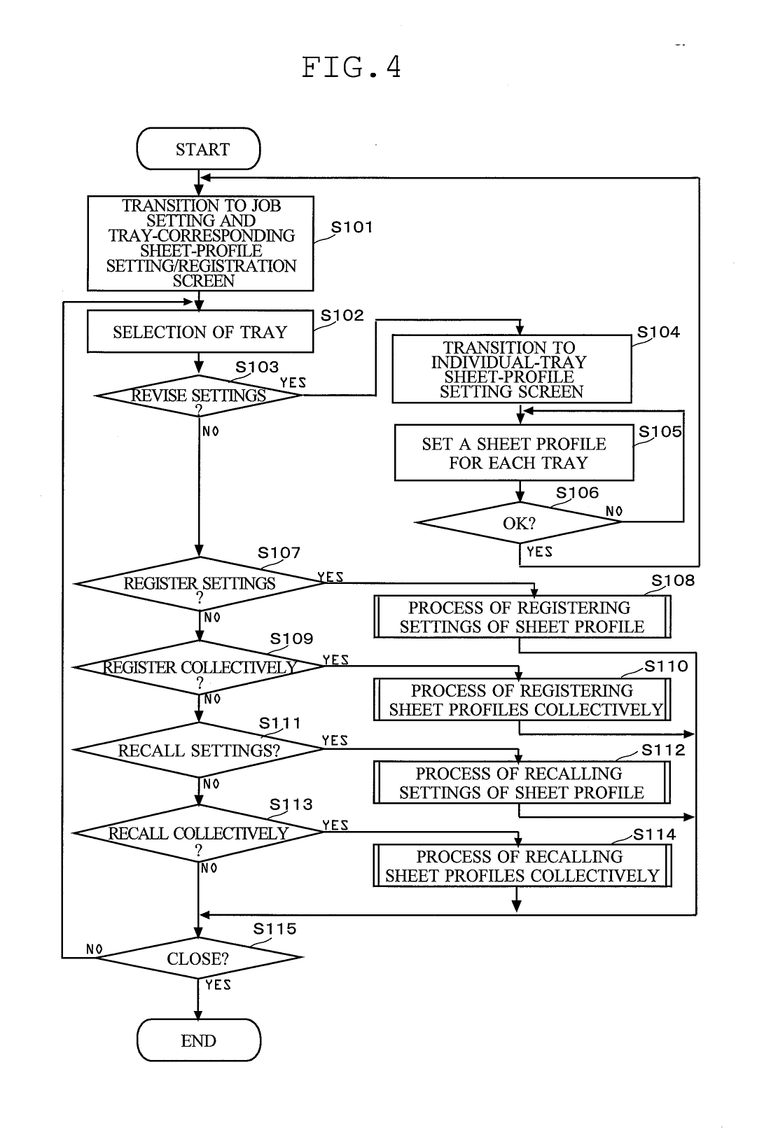

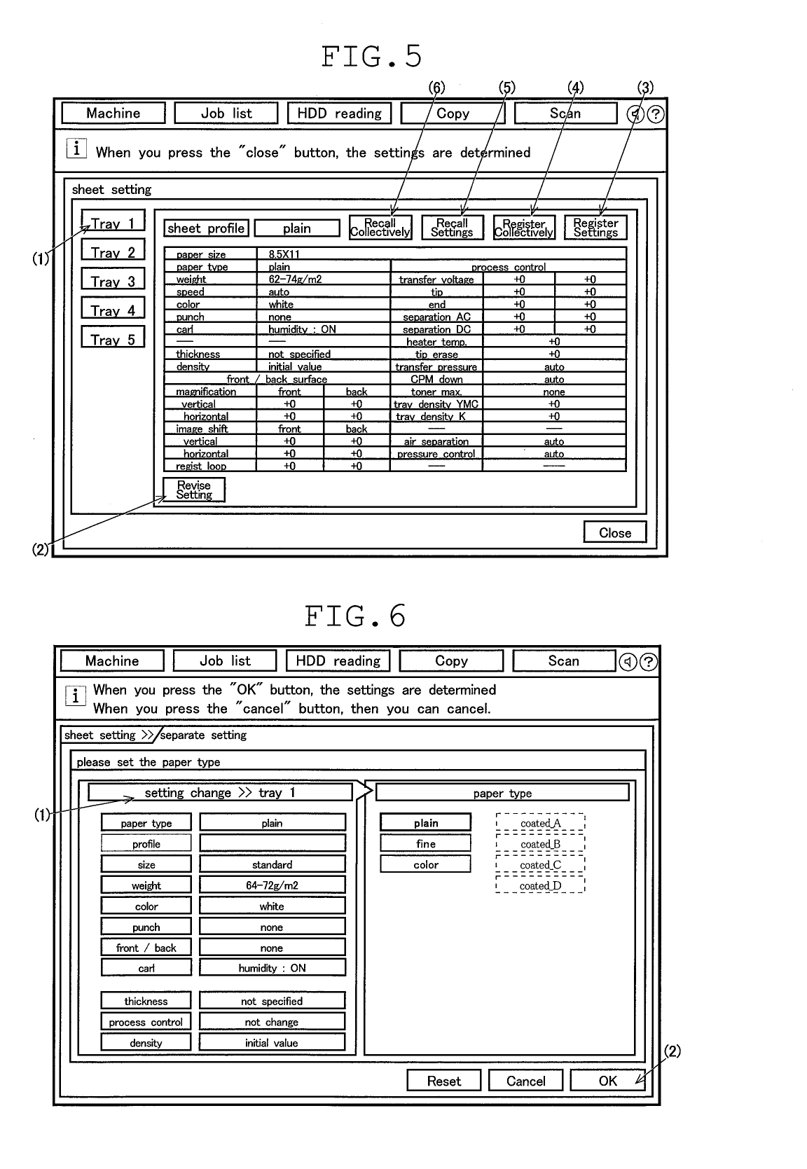

In the initial state, the main control section 150 displays on the operation/display section 123 a “job setting and tray-corresponding sheet-profile setting/registration” screen (FIG. 5), which is an initial screen for setting a job and registration of a profile (FIG. 4, step S101).

At this stage, a tray is selected by the operator through the operation/display screen 103 to set and register the sheet profile (FIG. 4, step S102). As shown in FIG. 5, suppose the state in which the “Tray 1” tab has been selected on the operation/display screen 103 by the operator in the case of the tray 1 to a tray 5 being displayed as candidates for selection ((1) of FIG. 5). In this case, how the sheet profile for the tray 1 is set is displayed on the job setting and tray-corresponding sheet-profile setting/registration screen.

Then, suppose the case of the operator having operated the “Revise Setting” tab ((2) of FIG. 5) in the state in which the tray 1 is selected as described above (FIG. 4, step S103: YES).

The main control section 150, having been operated as described above, displays a individual-tray sheet-profile setting screen (FIG. 6), which is a setting screen for setting the sheet profile for each tray, on the operation/display screen 103 (FIG. 4, step S104).

On this individual-tray sheet-profile setting screen (FIG. 6), the operator sets each item of the sheet profile including a paper type, a weight of paper, and a paper color of the sheet to be made to correspond to the tray 1, a difference of scale factors between two sides, a setting voltage of charging, and a transfer voltage (FIG. 4, step S105). The main control section 150 accepts setting until the “OK” tab on the individual-tray sheet-profile setting screen of FIG. 6 is operated (FIG. 4, step S106: NO and S105), and when the “OK” tab is operated (FIG. 4, step S106: YES), the job setting and tray-corresponding sheet-profile setting/registration screen (FIG. 5) to which the contents of the sheet having been set in the above-mentioned manner are reflected is displayed on the operation/display section 123 (FIG. 4, step S101).

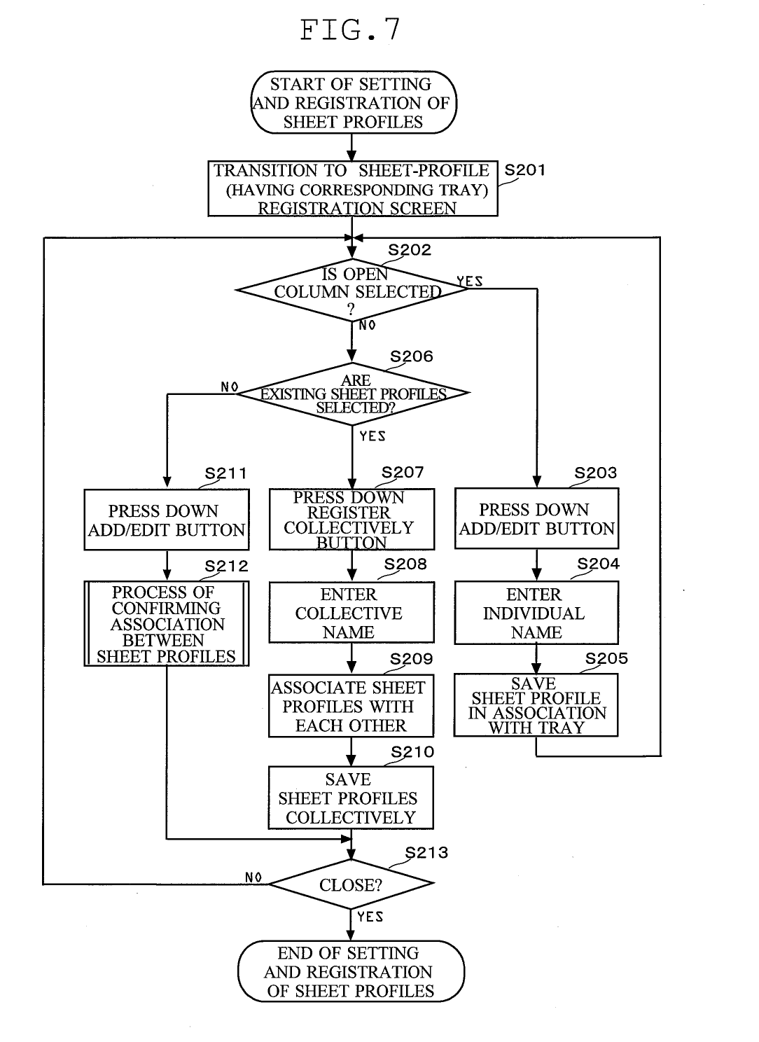

When the “Register Settings” tab ((3) of FIG. 5) is operated by the operator on this job setting and tray-corresponding sheet-profile setting/registration screen (FIG. 5) (FIG. 4, step S107: YES), a subroutine (FIG. 7) for performing a process of registering settings of sheet-profile is executed (FIG. 4, step S108) in order to register the contents of the sheet profile having been set in FIG. 6 and displayed in FIG. 5.

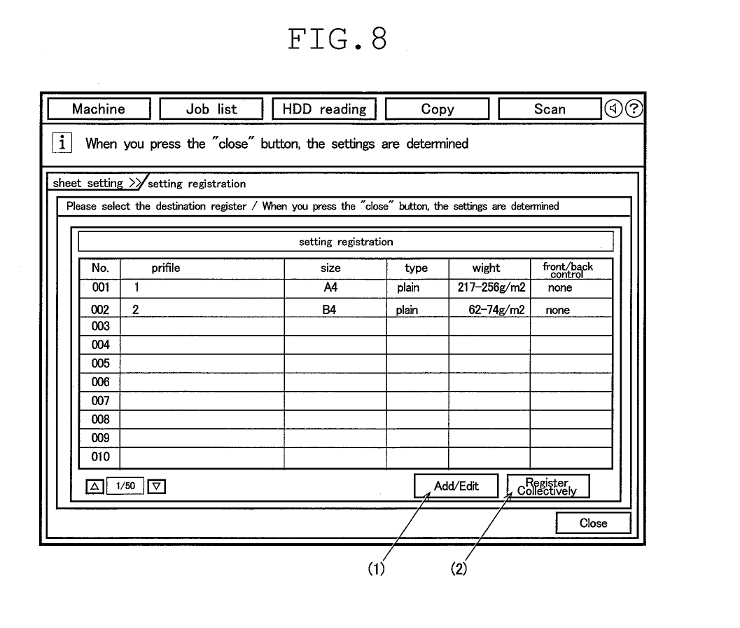

In the processing of the subroutine of FIG. 7, the main control section 150 displays a sheet-profile registration screen as shown in FIG. 8 on the operation/display screen 103 (FIG. 7, step S201).

Here, when an open column (No. 003 to No. 010) on the sheet-profile registration screen of FIG. 8 is selected by the operator (FIG. 7, step S202: YES), and the “Add/Edit” tab ((1) of FIG. 8) is pressed down by the operator (FIG. 7, step S203), a name for the sheet profile can be entered in the open column (FIG. 7, step S204), and the sheet profile set at step S105 of FIG. 4 can be registered to be made to correspond to the tray (FIG. 7, step S205).

Alternatively, when some of the existing sheet profiles (FIG. 8, No. 001 and No. 002) instead of the open columns are arbitrarily selected on the sheet-profile registration screen of FIG. 8 by the operator (FIG. 7, step S202: NO and S206: YES), and the “Register Collectively” tab ((2) of FIG. 8) is pressed down (FIG. 7, step S207), a name for the aggregation of the selected sheet profiles can be entered (FIG. 7, step S208), and these sheet profiles can be associated with each other (FIG. 7, step S209) and can be collectively registered (FIG. 7, step S210).

Alternatively, when the “Add/Edit” tab ((1) of FIG. 8) is pressed down on the sheet-profile registration screen of FIG. 8 in the state where neither the open columns nor plural ones of the existing sheet profiles but one of the existing sheet profiles is selected (FIG. 7, step S202: NO, 5206: NO, S211), the main control section 150 performs a process of confirming the association between sheet profiles (FIG. 7, step S212). In this process of confirming the association between sheet profiles, edit of the sheet profile belonging to the sheet profiles associated with each other is limited, and edit of the sheet profile not associated with each other is allowed. It should be noted that the process of confirming the association between sheet profiles is described in detail later.

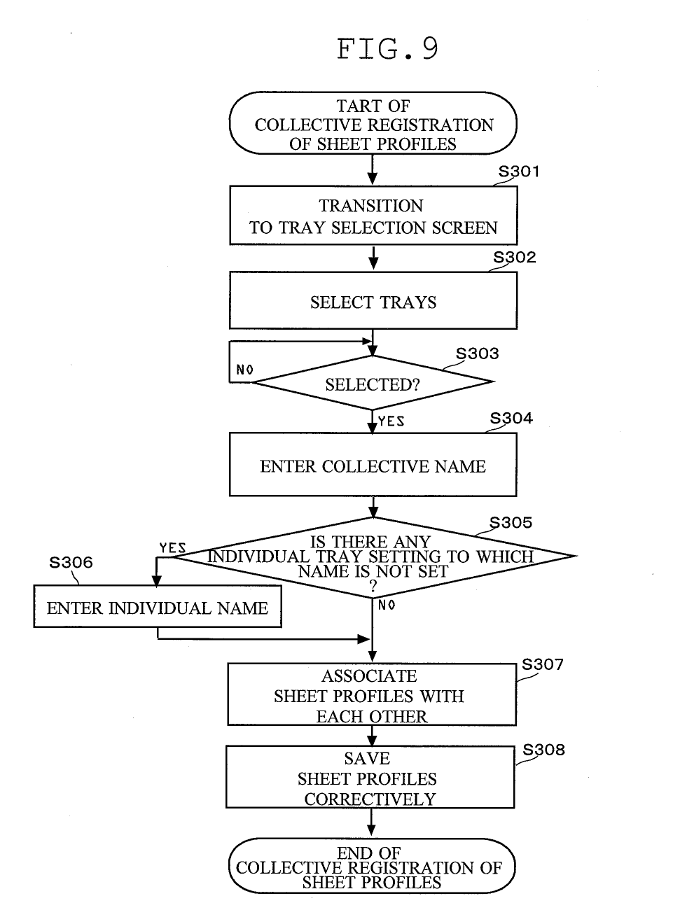

When the “Register Collectively” tab ((4) of FIG. 5) is operated by the operator on the job setting and tray-corresponding sheet-profile setting/registration screen (FIG. 5) (FIG. 4, step S109: YES), a subroutine for a process of registering settings of sheet-profile (FIG. 9) is executed to collectively register the contents of the sheet profiles having been set in FIG. 6 and displayed in FIG. 5 (FIG. 4, step S110).

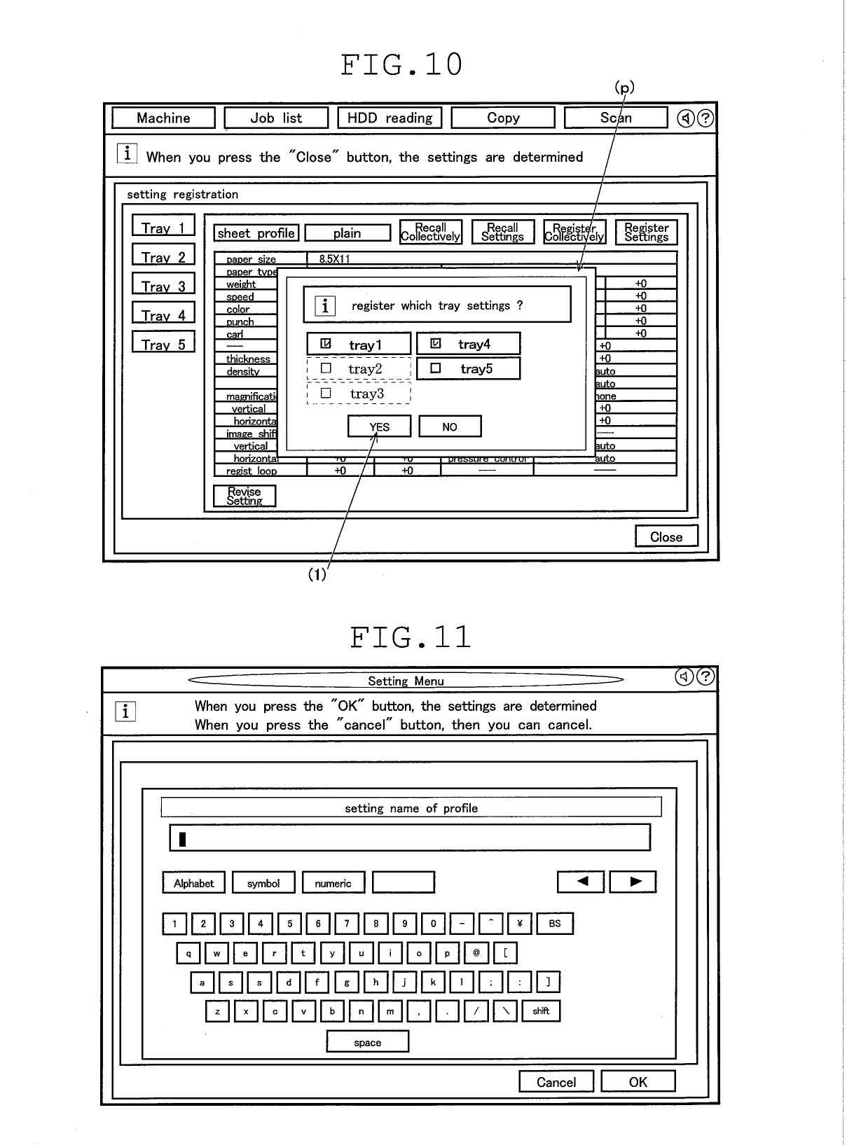

In this subroutine, the main control section 150 displays a tray selection screen on the job setting and tray-corresponding sheet-profile setting/registration screen (FIG. 5) by using a pop-up screen with check boxes and the like (FIG. 10(p)) (FIG. 9, step S301).

Then, referring to the tray selection screen, the operator selects a combination of the trays corresponding to the sheet profiles which the operator wants to put in a state where they are associated with each other (FIG. 9, step S302).

On the pop-up screen (p) of FIG. 10, the check boxes show represent the state that the sheet profiles of the tray 1, the tray 4, and the tray 5 can be selected for collective registration.

In addition, in the pop-up screen (p) of FIG. 10, the check boxes show that the sheet profiles of the tray 2 and the tray 3 are in a grayed out state, in which they cannot be selected for collective registration.

When the operator select the trays corresponding to the sheet profiles which should be collectively registered (FIG. 9, step S302), and presses down the “OK” button (FIG. 9, step S303: YES), the main control section 150 displays a name input screen shown in FIG. 11 on the operation/display screen 103. The operator enters a collective name for the aggregation of the sheet profiles corresponding to the selected trays on the name input screen of FIG. 11 (FIG. 9, step S304).

It should be noted that if a sheet profile not yet registered as an individual sheet profile is included in the sheet profiles corresponding to the trays selected as above-described, the main control section 150 display the name input screen shown in FIG. 11 on the operation/display screen 103. The operator enters a name for the sheet profile not yet registered as an individual sheet profile on the name input screen of FIG. 11 (FIG. 9, step S305: YES, S306).

Thus, the main control section 150 associates the sheet profiles with each other (FIG. 9, step S307), and collectively registers the sheet profiles (FIG. 9, step S308).

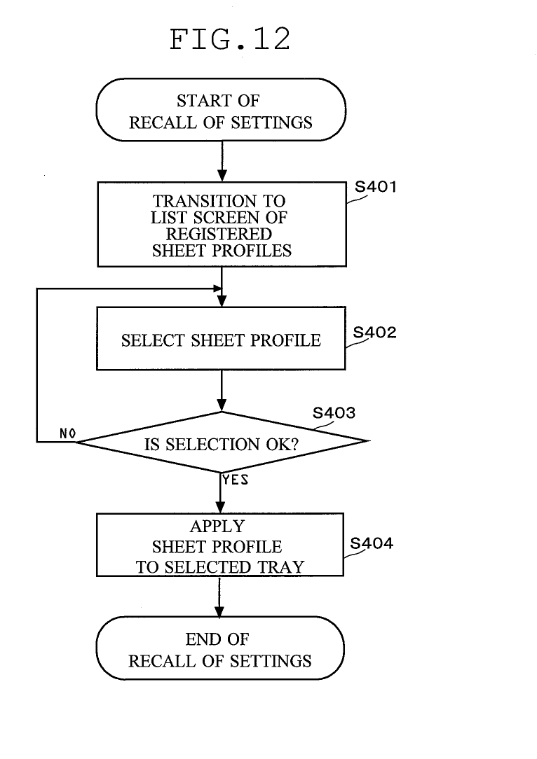

Alternatively, the “Recall Settings” tab ((5) of FIG. 5) is operated on the job setting and tray-corresponding sheet-profile setting/registration screen (FIG. 5) by the operator (FIG. 4, step S111: YES), a subroutine (FIG. 12) for performing a process of recalling sheet-profile-settings is executed in order to recall the set contents of any of the sheet profiles (FIG. 4, step S112).

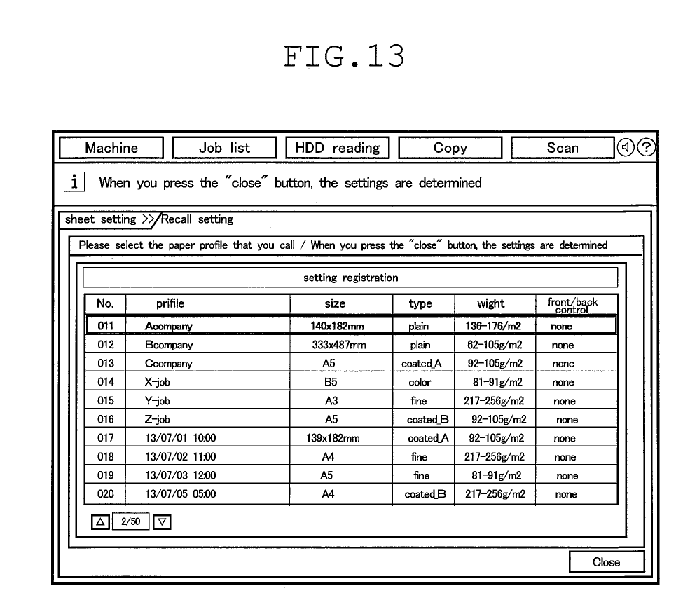

In this subroutine, the main control section 150 displays a recall settings screen (FIG. 13) on the operation/display screen 103 (FIG. 12, step S401, FIG. 13). On this recall settings screen (FIG. 13), the sheet profiles already registered are shown in a list. It should be noted that on the recall settings screen of FIG. 13, if the sheet profile which is made to correspond to a tray and has the tray information but does not match the selected tray (FIG. 4, step S102) is made not recallable at this stage by means of graying out or other manners. In addition, the sheet profiles which are associated with each other and are collectively registered are also made not recallable at this stage.

When the operator selects the sheet profile to be recalled (FIG. 12, step S402) and then presses down a “Close” button (FIG. 12, step S403: YES), the main control section 150 applies the sheet profile selected on the recall settings screen of FIG. 13 to the selected tray (FIG. 4, step S102, step S404).

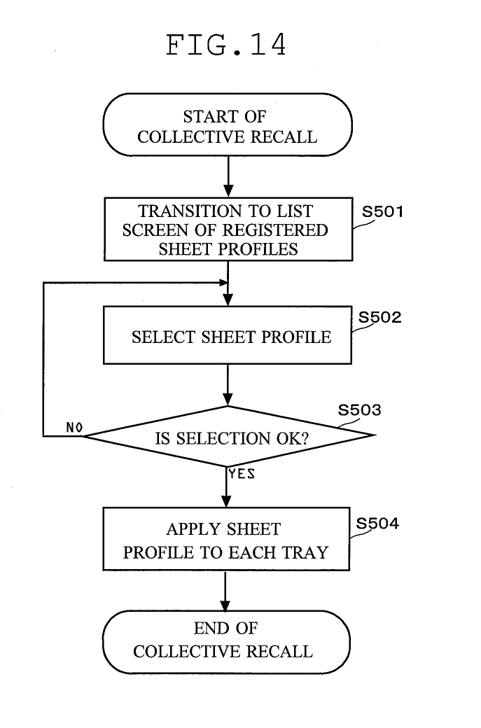

Alternatively, on the job setting and tray-corresponding sheet-profile setting/registration screen (FIG. 5), when a “Recall Collectively” tab ((6) of FIG. 5) is operated by the operator (FIG. 4, step S113: YES), a subroutine (FIG. 14) for performing a process of collectively recalling sheet profiles is executed (FIG. 4, step S114) in order to collectively recall the set contents of the sheet profiles associated with each other.

In this subroutine, the main control section 150 displays a collective recall screen (Fig. 13) on the operation/display screen 103 (FIG. 14, step S501, FIG. 13). On this collective recall screen (FIG. 13), the sheet profiles already collectively registered are shown in a list. It should be noted that on the collective recall screen of FIG. 13, the sheet profiles not collectively registered are made not recallable at this stage by means of graying out or other manners.

When the operator selects the sheet profile to be recalled (FIG. 14, step S502) and presses down the “Close” button (FIG. 14, step S503: YES), the main control section 150 applies the sheet profile selected on this collective recall screen of FIG. 13 to the selected tray (FIG. 4, step S 102, step S504).

As described above, until the operator operates the “Close” button (FIG. 4, step S115) on the job setting and tray-corresponding sheet-profile setting/registration screen (FIG. 5), the following steps are performed with respect to the selected tray (FIG. 4, step S102): recalling the settings of the sheet profile (FIG. 4, step S112); collectively recalling the sheet profiles (FIG. 4, step S114); revising the settings of the sheet profile (FIG. 4, step S105); registration of the settings of the sheet profile (FIG. 4, step S108); and collectively registering the sheet profiles (FIG. 4, step S110).

### <Sheet Profile Management (2)>

A second example of a sheet profile management in the image forming system of the embodiment is described here with reference to the flow charts and the examples of screen display. Here, description is made on setting and registration of a sheet profile not to be made to correspond to any one tray in the tray unit 30 or in the sheet supply section 130.

It should be noted that the sheet profile management of the embodiment can be performed also through an external computer; however, a description here is made taking the case as a specific example, in which case the management is performed through the operation/display section 123 of the image forming device 100.

In the initial state, the main control section 150 displays on the operation/display section 123 a “job setting and tray-corresponding sheet-profile setting/registration” screen (FIG. 5), which is an initial screen for setting a job and registration of a profile (FIG. 4, step S101).

Suppose here that without selecting any tray for setting or registering the sheet profile through operation/display screen 103 ((1) of FIG. 5, nothing), the operator has operated a “Register Settings” tab ((3) of FIG. 5) on the operation/display screen 103 (equivalent to FIG. 4, step S102: nothing, step S107: YES).

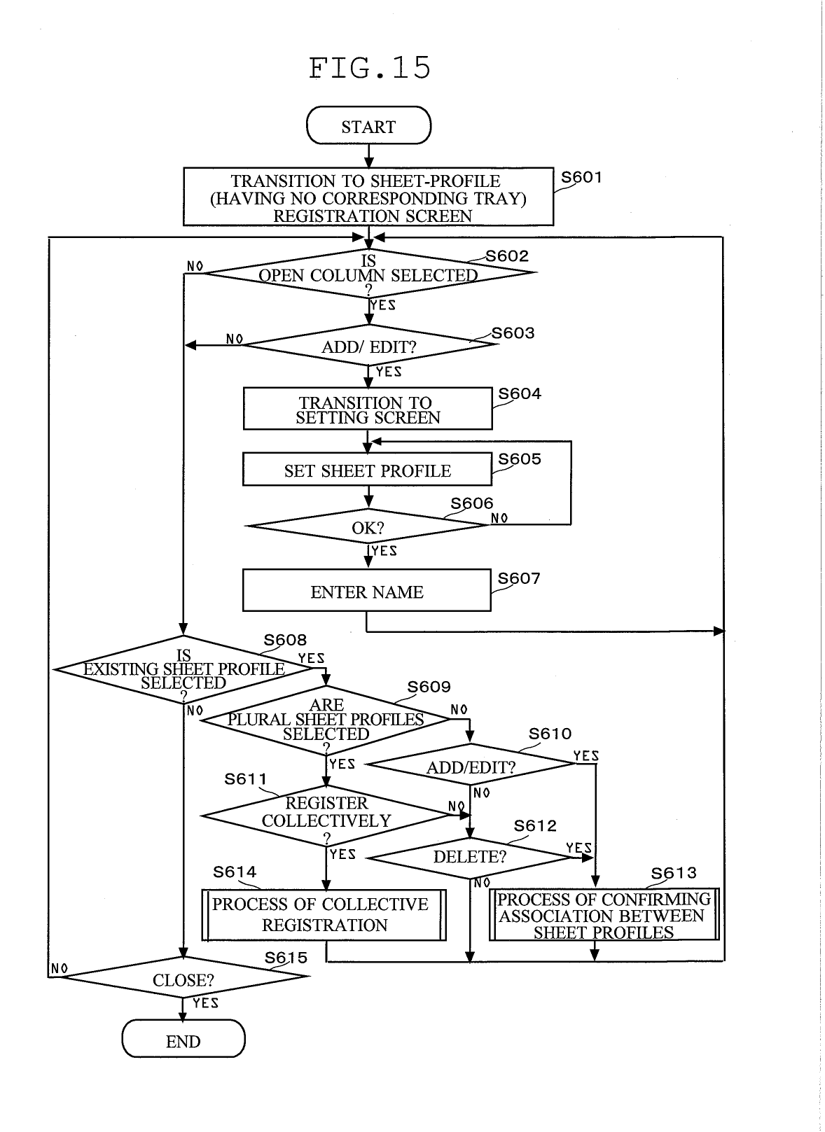

Having been operated as above-mentioned, the main control section 150 executes a subroutine (FIG. 15) for performing the process of registering settings of sheet-profile having no corresponding tray (equivalent to FIG. 4, step S108).

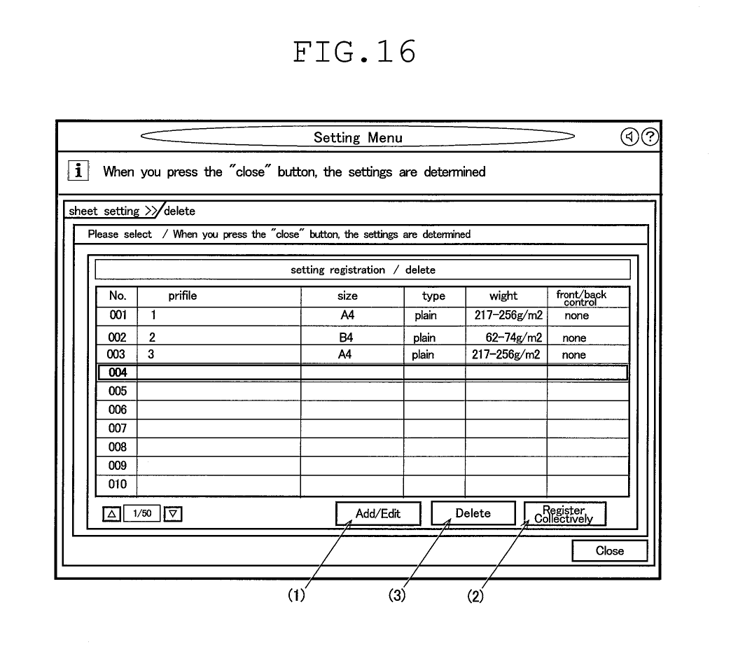

In the process of the subroutine of FIG. 15, the main control section 150 displays a sheet-profile registration screen as shown in FIG. 16 on the operation/display screen 103 (FIG. 15, step S601).

When the operator selects the open columns (No. 004 to No. 010) on the sheet-profile registration screen of FIG. 16 (FIG. 15, step S602: YES), and presses down the “Add/Edit” tab ((1) of FIG. 16) (FIG. 15, step S603: YES), the main control section 150 displays a sheet-profile setting screen (FIG. 17) for a sheet profile having no corresponding tray on the operation/display screen 103 (FIG. 15, step S604). The screen of FIG. 16 shows the situation where the sheet profile is about to be registered in the open column No. 004.

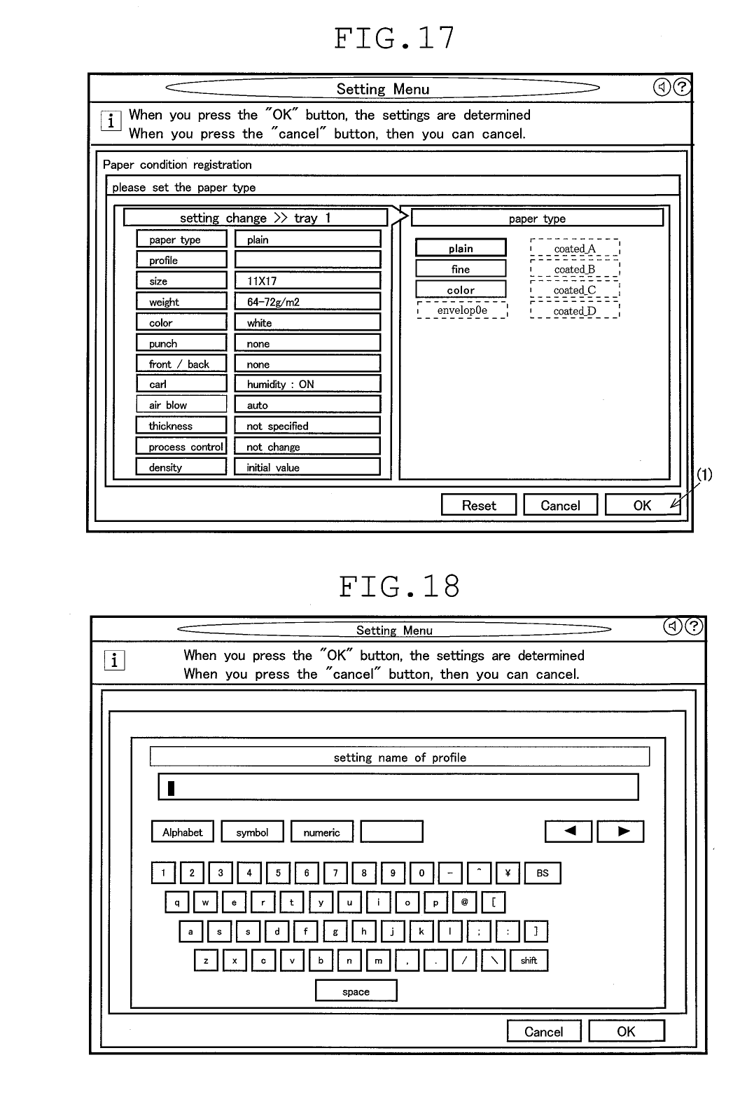

On this sheet-profile setting screen (FIG. 17), the operator sets each item of the sheet profile including a paper type, a weight of paper, and a paper color of a sheet, a difference of scale factors between two sides, a setting voltage of charging, and a transfer voltage (FIG. 15, step S605). The main control section 150 accepts setting until the “OK” tab ((1) of FIG. 17) on the sheet-profile setting screen of FIG. 17 is operated (FIG. 15, step S606: No, S605). The main control section 150 displays the name input screen shown in FIG. 18 on the operation/display screen 103 when the “OK” tab is operated (FIG. 15, step S606: YES). The operator enters the name of the sheet profile on the name input screen of FIG. 18 (FIG. 15, step S607). Then, the main control section 150 changes the operation/display screen 103 back to the screen display of FIG. 16. On this operation/display screen 103, the registered sheet profile is displayed in column No. 004.

Alternatively, the operator select arbitrary some of the existing sheet profiles (No. 001 to No. 003 in FIG. 16), instead of open columns, on the sheet-profile registration screen of FIG. 16 (FIG. 15, step S602: NO, step S608: YES, step S609: YES). On the sheet-profile registration screen of FIG. 20, the sheets No. 001, No. 002, and No. 004 corresponding to the selected three sheet profiles are shown.

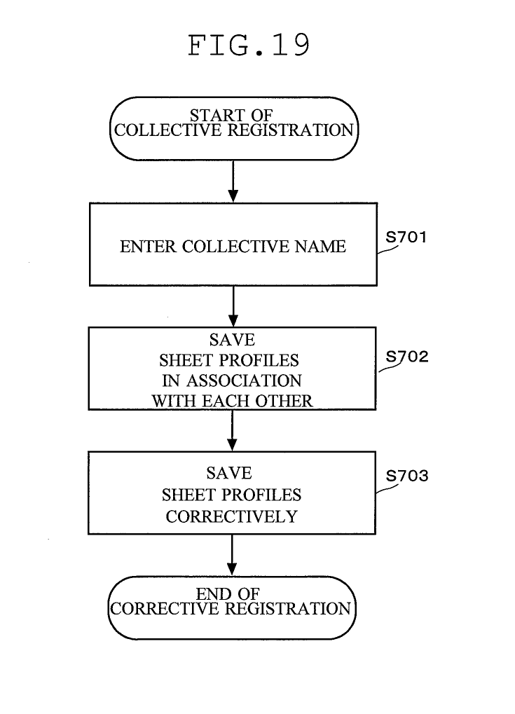

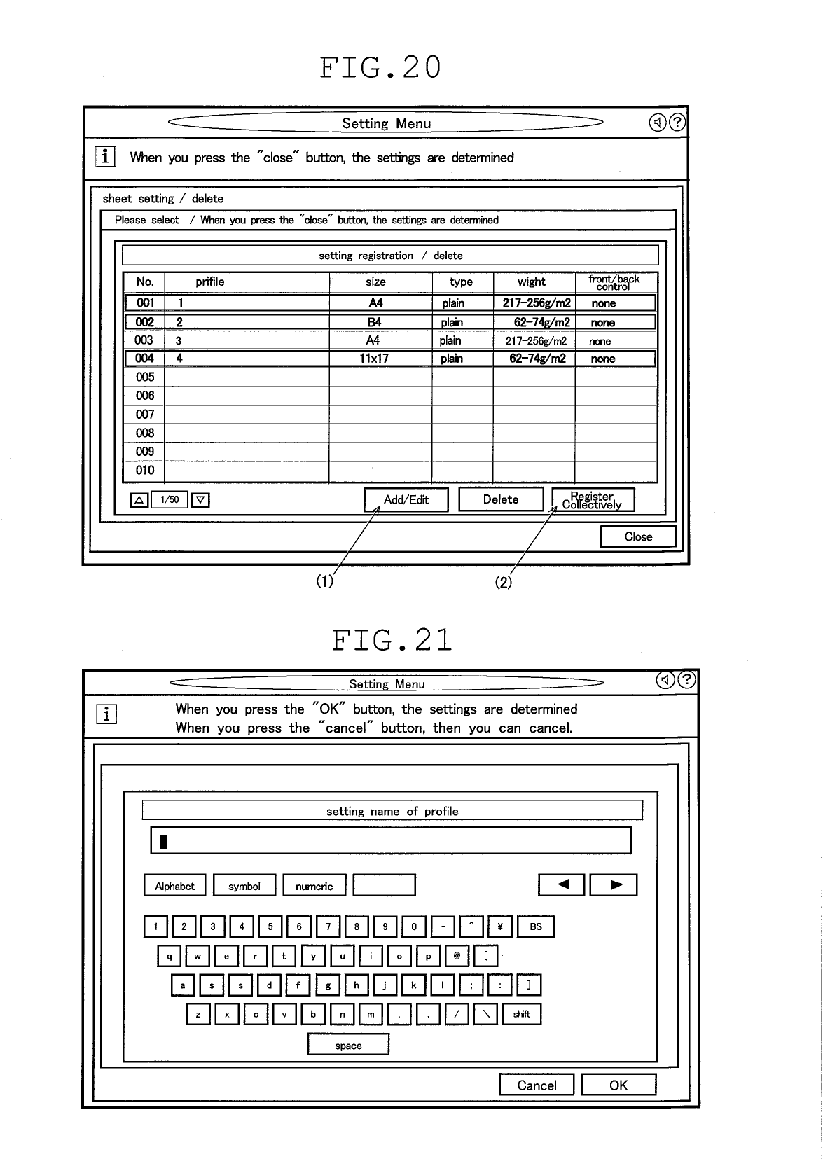

On this sheet-profile registration screen, the main control section 150 grays out the “Add/Edit” tab ((1) of FIG. 16, (1) of FIG. 20) so that that tab cannot not be selected. In this situation, when the operator presses down the “Register Collectively” tab ((2) of FIG. 16, (2) of FIG. 20) on the operation/display screen 103 (FIG. 15, step S611: YES), these sheet profiles are collectively registered (FIG. 15, step S614). That is to say, entering the name of the aggregation of the selected sheet profiles on the name input screen of FIG. 21 (FIG. 19, step S701) allows the main control section 150 to collectively register the selected sheet profiles in association with each other (FIG. 19; step S702; FIG. 19, step S703).

Alternatively, on the sheet-profile registration screen of FIG. 16, arbitrary some of the existing sheet profiles (No. 001 to No. 003 in FIG. 16), instead of the open columns (FIG. 15, step S602: NO, step S608: YES), are selected by the operator, and pressed down a “Delete” tab ((3) of FIG. 16, (3) of FIG. 18) on the operation/display screen 103 (FIG. 15, step S612: YES), the main control section 150 performs the process of confirming the association between sheet profiles (FIG. 15, step S613).

Alternatively, the operator selects, on the sheet-profile registration screen of FIG. 16, any one of the existing sheet profiles (No. 001 to No. 003 in FIG. 16) instead of the open column (FIG. 15, step S608: YES, step S609: NO), and pressed down the “Add/Edit” tab ((1) of FIG. 16, (1) of FIG. 18) (FIG. 15, step S610: YES) or the “Delete” tab ((3) of FIG. 16, (3) of FIG. 18) on the operation/display screen 103 (FIG. 15, step S610: NO, step S612: YES), the main control section 150 performs the process of confirming the association between sheet profiles (FIG. 15, step S613).

In this process of confirming the association between sheet profiles, it is limited to edit and delete the sheet profile belonging to the sheet profiles associated with each other, and it is allowed to edit the sheet profiles not associated with each other. Note that the process of confirming the association between sheet profiles is described in detail later.

In the above-described operations, the main control section 150 goes back to the state of waiting operations (FIG. 15, step S602) on the screen of FIG. 16, in the following cases: the operations of the operator were none of delete, addition/edit, and collective registration (FIG. 15, step S612: NO); the process of confirming the association between sheet profiles (FIG. 15, step S613) has been performed; or the collective registration (FIG. 15, step S614) has been performed.

It should be noted that the main control section 150 continues to perform the processing as shown by the flow chart of FIG. 15 until the operator operates the “Close” button (FIG. 15, step S615) on the sheet profile setting/registration screen (FIG. 16).

### <Sheet Profile Management (3)>

A third example of the sheet profile management of the image forming system of the embodiment is described here with reference to the flow charts and the examples of screen display. A description is made here on recalling the sheet profiles

It should be noted that the sheet profile management of the embodiment can be performed also through an external computer; however, a description is made here taking the case as a specific example, in which case the management is performed through the operation/display section 123 of the image forming device 100.

When the registered sheet profile is recalled, the intended sheet profile is recalled from the collective recall screen of FIG. 13.

When the sheet profile corresponding to a tray is recalled, the settings of the recalled sheet profile applies to the corresponding tray. That is, when the sheet profiles corresponding to trays and being collectively registered are recalled, the settings of each of the collectively recalled sheet profiles apply to the corresponding tray.

Alternatively, when recalling the sheet profiles having no corresponding trays and being collectively registered, the settings of each of the collectively recalled sheet profiles can apply to the trays connected to the image forming device 100 in order of increasing. Instead, the main control section 150 can determine the applicability of the recalled sheet profiles to the sheets stored in the trays, and the appropriate sheet profile can apply to the appropriate tray.

### <Sheet Profile Management (4)>

As a fourth example of the sheet profile management of the image forming system of the embodiment, the process of confirming the association between sheet profiles (the processing at step S212 in FIG. 7 on the screen of FIG. 8, and the processing at step S613 in FIG. 15 on the screen of FIG. 16) is described here in detail with reference to the flow charts.

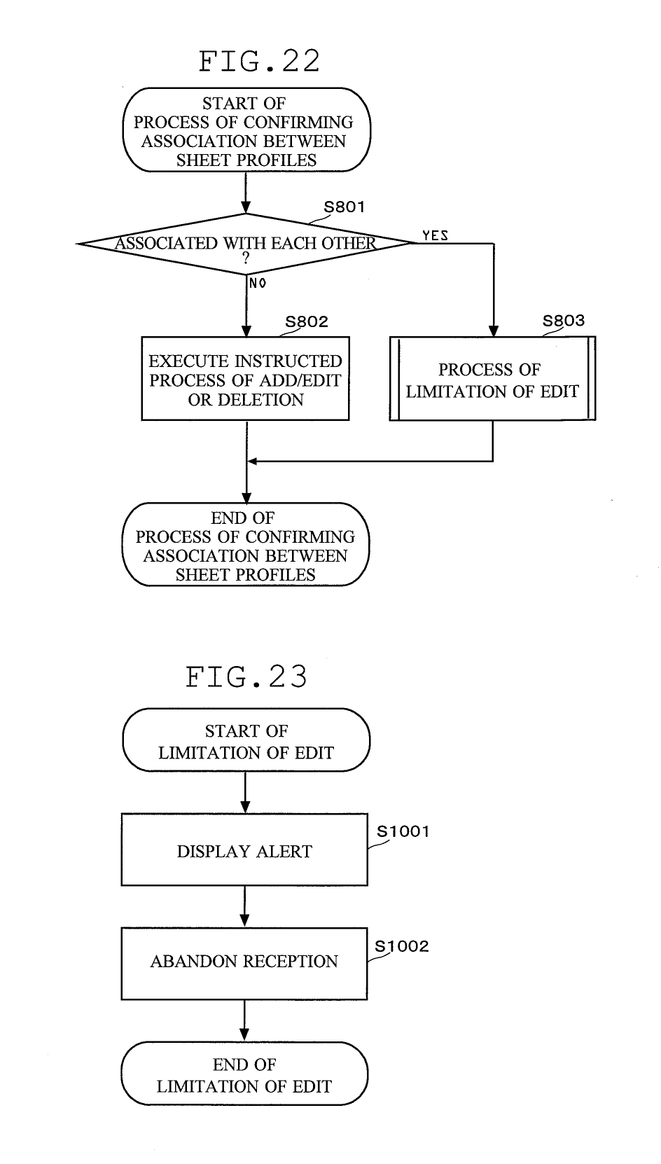

In the process of confirming the association between sheet profiles, the main control section 150 confirms whether the sheet profiles are associated with each other (FIG. 22, step S801). Further, in this process of confirming the association between sheet profiles, the main control section 150 allows edit of the sheet profiles not associated with each other (FIG. 22, step S801: NO) (FIG. 22, step S802), and limits edit and deletion of the sheet profiles belonging to the sheet profile associated with each other (FIG. 22, step S801: YES) (FIG. 22, step S803). With this measure, even when the sheet profiles are referred to to perform a certain image forming, part of the sheet profiles are prevented from being inadvertently revised. As a result, all the sheet profiles referred to for a certain image forming are precisely reproduced. In addition, all the sheet profiled referred to for a certain image forming are associated with each other so that they are easy to handle, thereby reducing the burden of the operator.

### <4-1: Example of Limitation of Edit (1)>

When the “Add/Edit” is selected on the screen of FIG. 8 (FIG. 7, step S212) or the “Add/Edit” or the “Delete” is selected on the screen of FIG. 16 (FIG. 15, step S613), the process of limiting edit and deletion (FIG. 22, step S803) displays an alert such as “Alert: Selected sheet profiles are associated with each other; therefore, they are protected. The operation of edit or deletion is not accepted.” on the screen (FIG. 23, step S1001), and abandons the operation of edit or delete (FIG. 23, step S1002).

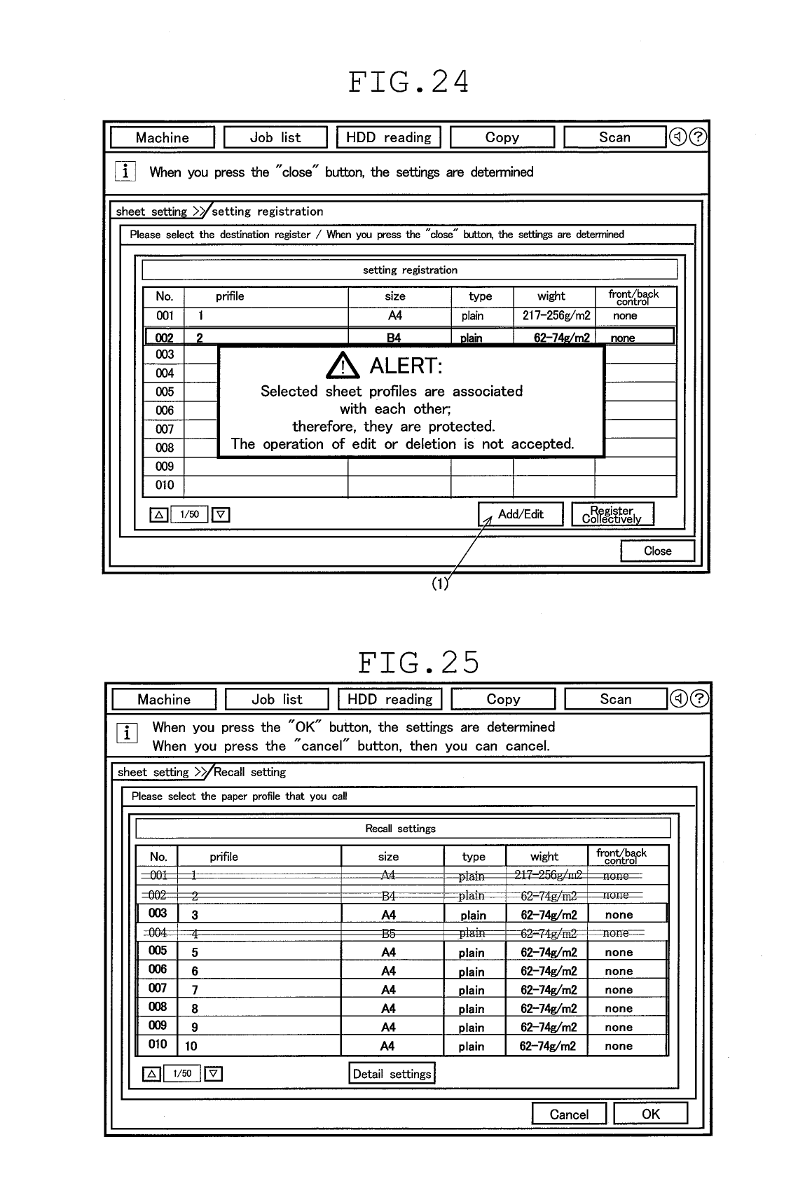

FIG. 24 shows an example where the “Add/Edit” ((1) of FIG. 24) has been operated while the sheet profile 002 was selected on a screen similar to FIG. 8, and the above-described alert screen is popped up.

Further, in the case where the “Recall Settings” tab is pressed down in the screen of FIG. 5 to recall the list of the sheet profiles to edit, it is also preferable that the main control section 150 displays the sheet profiles which are associated with each other and cannot be edited in an unselectable state by means of graying out or other manner (FIG. 25). FIG. 25 shows an example in which the sheet profiles 001, 002, and 004 are not selectable.

As described above, edit and delete of the sheet profiles already associated with each other is prohibited; thus, a situation is prevented in which even when a plurality of the sheet profiles are referred to to perform a certain image forming, part of the sheet profiles are inadvertently revised. As a result, all the sheet profiles referred to for a certain image forming are precisely reproduced.

### <4-2: Example of Limitation of Edit (2)>

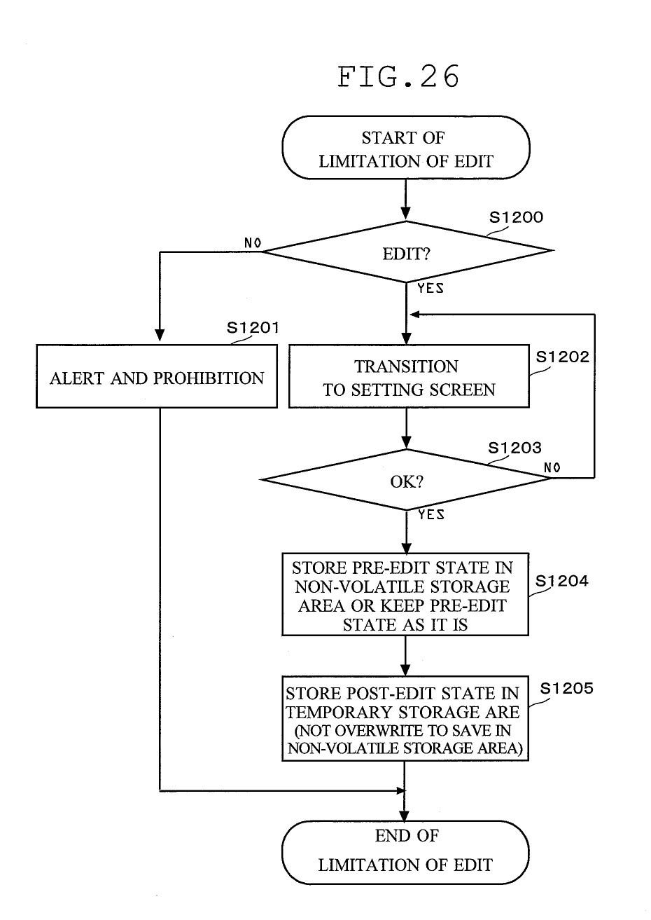

In another example of the process of limiting edit and deletion (FIG. 22, step S803), when the “Add/Edit” is selected on the screen of FIG. 8 (FIG. 7, step S212), or the “Add/Edit” or the “Delete” is selected on the screen of FIG. 16 (FIG. 15, step S613), the main control section 150 determines whether the instruction is edit or deletion (FIG. 26, step S1200).

When the instruction of the operator is deletion (FIG. 26, step S1200: NO), the instruction is prohibited in the same way as Example of Limitation (1) described in FIG. 24 above (FIG. 26, step S1201).

When the instruction of the operator is edit (FIG. 26, step S1200: YES), the main control section 150 displays the setting screen such as FIG. 16 on the operation/display screen 103, and accepts the edit of the sheet profile (FIG. 26, step S1202). It should be noted that when accepting such edit, a pop-up screen can be used to display a message, for example, “Although the sheet profile to be edited from now on is associated with another sheet profile, do you still want to continue to edit?”

When the edit of the sheet profile has been finished (FIG. 26, step S1203: YES), the main control section 150 stores the state of the sheet profile before edit in a storing section such as the non-volatile memory 159c, or keeps the state of the sheet profile before edit without giving any modification (FIG. 26, step S1204). Further, the main control section 150 stores the state of the sheet profile after edit in a work area or a temporary memory area such as a volatile storing section including the RAM 159b or the like (FIG. 26, step S1205). That is, the edited sheet profile is used only for a temporary use, and the sheet profile before edit is kept as it is.

As described above, in the case where the sheet profiles already associated with each other have been edited, the edited sheet profile is used only for a temporal use and not stored; thus, a situation is prevented in which even when a plurality of the sheet profiles are referred to to perform a certain image forming, a part of the sheet profiles are prevented from being inadvertently revised. As a result, all the sheet profiles referred to for a certain image forming are precisely reproduced.

### <4-3: Example of Limitation of Edit (3)>

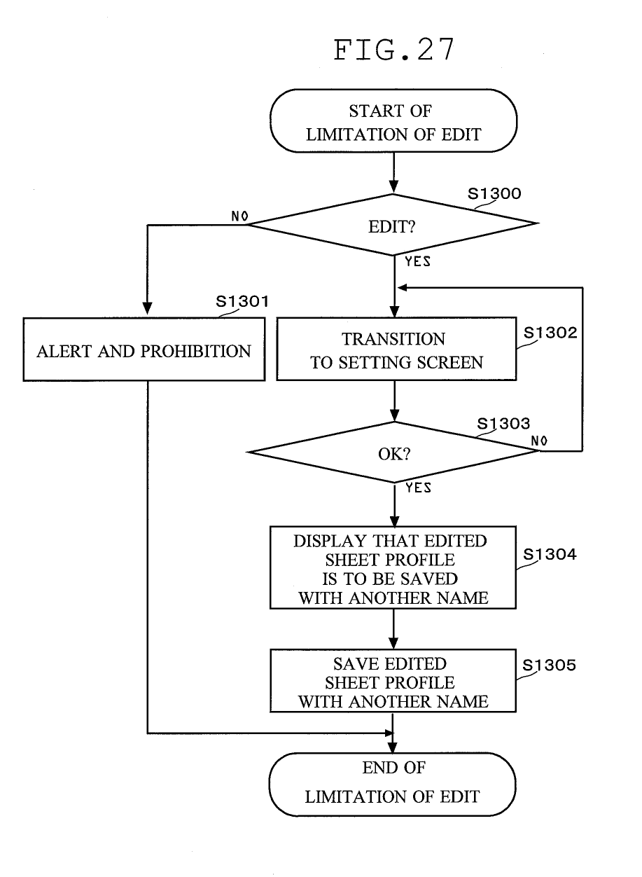

In another example of the process of limiting edit and deletion (FIG. 22, step S803), when the “Add/Edit” is selected on the screen of FIG. 8 (FIG. 7, step S212), or the “Add/Edit” or the “Delete” is selected on the screen of FIG. 16 (FIG. 15, step S613), the main control section 150 determines whether the instruction is edit or deletion (FIG. 27, step S1300).

When the instruction of the operator is deletion (FIG. 27, step S1300: NO), the instruction is prohibited in the same way as Example of Limitation (1) described in FIG. 24 above (FIG. 27, step S1301).

When the instruction of the operator is edit (FIG. 27, step S1300: YES), the main control section 150 displays the setting screen such as FIG. 16 on the operation/display screen 103, and accepts the edit of the sheet profile (FIG. 27, step S1302). It should be noted that when accepting such edit, a pop-up screen can be used to display a message, for example, “Although the sheet profile to be edited from now on is associated with another sheet profile, do you still want to continue to edit?”

When the edit of the sheet profile has been finished (FIG. 27, step S1303: YES), the main control section 150 displays on the setting screen “Edited sheet profile will be saved with another name” and the like (FIG. 27, step S1304). Further, the main control section 150 displays a name input screen as shown in FIG. 18 and the like, and save the edited sheet profile as a new sheet profile with the name entered by the operator (FIG. 27, step S1305). That is, the edited sheet profile is saved as a different sheet profile, and the sheet profile before edit is kept as it is.

As described above, in the case where the sheet profiles already associated with each other have been edited, the edited sheet profile is saved with a different name; thus, a situation is prevented in which even when a plurality of the sheet profiles are referred to to perform a certain image forming, a part of the sheet profiles are prevented from being inadvertently revised. As a result, all the sheet profiles referred to for a certain image forming are precisely reproduced.

### Other Embodiment

An embodiment of the present invention is described above with reference to the drawings; however, a specific configuration is not limited to that described in the embodiment, and is included in the present invention even if modification or addition is made without departing from the scope of the present invention.

As a method for associating a plurality of sheet profiles with each other, collective registration is taken as a specific example in the above-described embodiment; however, the method is not limited to that example. For example, by adding a sheet profile to the sheet profiles already associated with each other, it is possible to put the sheet profiles in a state where they are associated with each other as a whole. Alternatively, it is not precluded to associate the sheet profiles associated with each other to other sheet profiles.

In the above-described embodiment, the main control section 150 in the image forming device 100 controls with respect to the sheet profiles; however, there is no limitation thereto. For example, it is possible that a computer, not shown in the drawings, as an information processing apparatus manages or stores the sheet profiles as a control section.

The present U.S. patent application claims a priority under the Paris Convention of Japanese patent application No. 2012-163412 filed on Jul. 24, 2012, which shall be a basis of correction of an incorrect translation.

What is claimed is:

1. A sheet profile management method for managing sheet profiles which are information about sheets used in an image forming device, the method comprising the step of:
when storing produced sheet profiles, associating a plurality of sheet profiles, to be used to perform a certain image formation, with each other, and putting the associated sheet profiles in a state where limitation of edit is enforced.

2. The sheet profile management method of claim 1, wherein the limitation of edit is any one of the followings: prohibition of edit; temporal use of a result of edit; and storage of a result of edit with another name.

3. The sheet profile management method of claim 1, wherein each of the associated sheet profiles contains tray information on a tray in which the sheet is stored.

4. The sheet profile management method of claim 1, wherein each of the associated sheet profiles is assigned with a different tray in which the sheet is stored.

5. An image forming system comprising:
an image forming section configured to form, on a sheet, an image based on graphic data;
a storing section configured to store sheet profiles which are information about sheets to be used by the image forming section to form images; and
a control section configured to manage the sheet profiles stored in the storing section and to control the image forming section to form an image,
wherein when storing produced sheet profiles in the storing section, the control section associates a plurality of sheet profiles, to be used to perform a predetermined image formation, with each other, and puts the associated sheet profiles in a state where limitation of edit is enforced.

6. The image forming system of claim 5, wherein the control section controls to perform, as the limitation of edit, any one of the followings: prohibition of edit; temporal use of a result of edit;
and storage of a result of edit with another name.

7. The image forming system of claim 5, wherein the control section controls such that each of the associated sheet profiles contains tray information on a tray in which the sheet is stored.

8. The image forming system of claim 5, wherein each of the associated sheet profiles is assigned with a different tray in which the sheet is stored.

9. A computer readable non-transitory recording medium storing a sheet profile management program which causes a computer in an image forming device to realize the functions of:
an image forming section configured to form, on a sheet, an image based on graphic data;
a storing section configured to store sheet profiles which are information about sheets to be used by the image forming section to form images; and
a control section configured to manage the sheet profiles stored in the storing section and to control the image forming section to form an image,
wherein when storing produced sheet profiles in the storing section, the control section associates a plurality of sheet profiles, to be used to perform a predetermined image formation, with each other, and puts the associated sheet profiles in a state where limitation of edit is enforced.

10. The computer readable non-transitory recording medium of claim 9, wherein the control section is caused to perform, as the limitation of edit, any one of the followings: prohibition of edit;
temporal use of a result of edit; and storage of a result of edit with another name.

11. The computer readable non-transitory recording medium of claim 9, wherein the control section is caused to control such that each of the associated sheet profiles contains tray information on a tray in which the sheet is stored.

12. The computer readable non-transitory recording medium of claim 9, wherein the control section is caused to function such that each of the associated sheet profiles is assigned with a different tray in which the sheet is stored.
